(19) United States
(12) Patent Application Publication
(10) Pub. No.: US 2012/0223495 A1
(43) Pub. Date: Sep. 6, 2012

(54) Floor Level Rolling Work Platform

(76) Inventors: Kenneth J. Bauer, Hudson, WI (US); Jacqueline May Chavez, Hudson, WI (US)

(21) Appl. No.: 13/407,267

(22) Filed: Feb. 28, 2012

Related U.S. Application Data
(60) Provisional application No. 61/464,234, filed on Mar. 1, 2011.

(51) Int. Cl. B25H 5/00

(52) U.S. Cl. 280/32.5

(57) ABSTRACT

A low profile floor level rolling work platform comprised of a sheet of rigid material joined on the underside by a plurality of multi-directional friction-reducing devices of a predetermined size, quantity and position thereby providing a means by which a workman can sit and remain seated while moving from one work location to another by the thrust of a hand, arm, leg or foot and eliminating the existing method of crouching, bending or kneeling and then standing erect and walking to reach a new location.

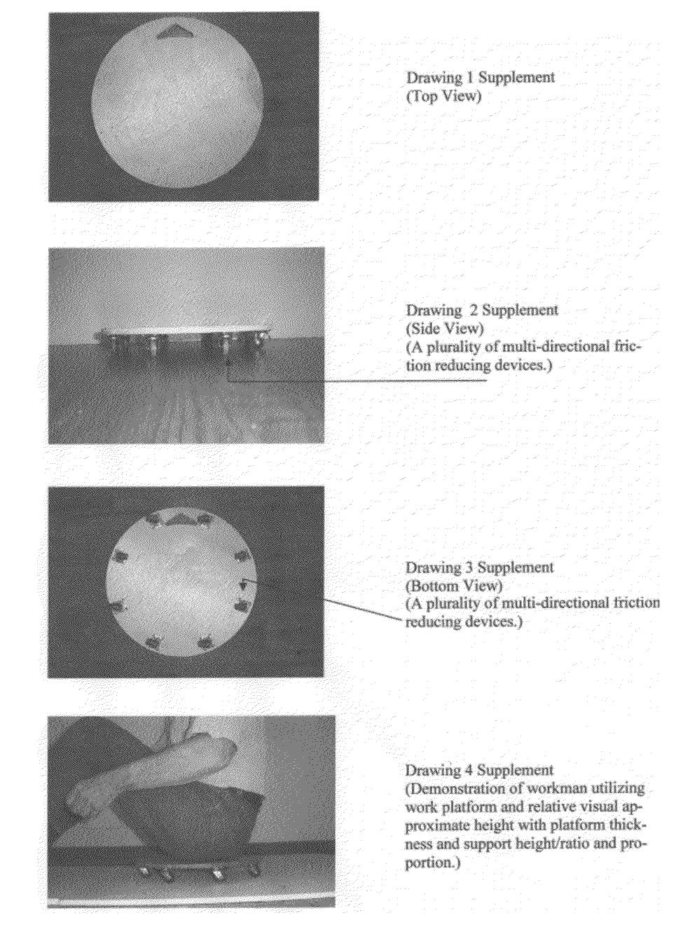

### CROSS-REFERENCE TO RELATED APPLICATIONS

This application claims the benefit of Provisional Patent Application Ser. No. 61464234030111 filed on Mar. 1, 2011 by present inventors.

### BACKGROUND OF THE INVENTION

1. Field of Invention

This invention relates to rolling work platforms, specifically to a floor level rolling work platform.

2. Prior Art

Workmen commonly perform work operations at floor level. The existing method for carrying out such work operations require the workman to crouch, bend or kneel and then stand erect and walk to reach a new work location.

The above repetitious and strenuous common method through the course of a work day ordinarily results in excessive workman fatigue and may prove difficult or impossible for an older workman or workman with a physical handicap.

Preliminary research did not reveal any tool or technique to improve on the above common method. However, the wheeled shop stool and the auto repair dolly designs have been observed and then excluded from consideration as follows:

In the case of the wheeled shop stool, the design intent is to allow work operations to be performed at approximately waist high level. Its minimum seating height is typically greater than 8 inches. Excessive nominal working height and stability issues, as well as tended use, render the wheeled shop stool unsuitable for any floor level work operations.

In the case of the auto repair dolly, the design intent provides for a mechanic to perform work operations face up on the underside of automobiles while lying on his back. The platform of the auto repair dolly is typically fitted with a formed or attached padded head rest. The platform shape is elongated, that is to say rectangular to coincide with the workman's body shape and his back and shoulders. Casters are fitted to the underside of the platform and are typically positioned inward from the edges of the platform. Both of these features enhance linear movement. Positioning of the casters toward the center results in some instability and the platform tends to tip when the workman shifts his weight. Platform shape, location of casters, headrest obstruction, rectangular shape and size, i.e. 16 inches×32 inch (approximate). These factors and the weight resulting from the size, as well as its intended use, render the auto repair dolly unsuitable and is therefore excluded as a similar application.

### OBJECTS AND ADVANTAGES

The intent of said work platform is to provide a new and improved method whereby a workman can perform said work while sitting on a compact floor level rolling work platform and can remain seated while propelling himself from one work location to another with the thrust of extending a hand, arm, or leg thereby replacing the existing common method requiring a workman to crouch, bend or kneel and then stand erect and walk to reach a new work location.

The installation of floor tile and laminate flooring, electrical work on receptacles, floor cleaning, stocking of floor level shelving, are but a few examples of such work operations.

Accordingly, besides the objects and advantages alluded to in the above, several objects and advantages of said work platform are:
a) To provide a rolling work platform to accommodate workmen doing manual work on or near the floor or deck of a structure.
b) To provide a rolling work platform with a limited surface height above the floor that permits optimum mechanical advantage for low level push, pull, lift work operations.
c) To provide a rolling work platform with a sufficient number of multi-directional friction-reducing devices positioned to maximize platform stability.
d) To provide a rolling work platform that permits unrestricted multi-directional movement from one work location to another.
e) To provide a rolling work platform that separates a workman from a cool floor to avoid muscle damage.
f) To provide a rolling work platform that lends itself to additional universal applications.

Further objects and advantages of said work platform will become apparent from a consideration of the figures/photos with details and ensuing descriptions.

### SUMMARY

In accordance with the objects and advantages of said work platform, a compact low profile rolling work platform comprised of a panel supported by multi-directional friction-reducing devices such as casters on which a workman can sit that permit change of directional movement from one work location to another while remaining seated at floor level. This said compact platform will be constrained within practical height limitations to ensure push, pull, and lift mechanical advantage for the workman. In the preferred embodiment, the work platform will be constructed of materials suitable to meet or exceed weight, appearance, strength, and cost considerations.

### DRAWINGS LISTING

1. Perspective top view of said rolling work platform.

2. Perspective side/edge view of said rolling work platform.

3. Perspective bottom view of said rolling work platform.

4. Demonstrates a workman utilizing said rolling work platform.

### DETAILED DESCRIPTION

### Preferred Embodiment

A rolling work platform that is constructed of, but not limited to, wood, polymers, rubber, fiberglass, glass, steel, aluminum, or any combination thereof, so as to provide optimum weight, appearance, and cost considerations.

A preferred embodiment of said work platform is illustrated in Drawing 1 (top view), Drawing 2 (side view), Drawing 3 (bottom view) Drawing 4 (demonstrates workman utilizing work platform). Drawing 1 (top view) displays the physical shape of said work platform. This shape lends itself to functioning in confined workspace situations. Diameter of the platform is dependent upon a given model to accommodate both a workman's body size and workspace constraints.

Drawing 2 (side view) displays said work platform's physical profile supported by friction reducing devices (Detail A).

Drawing 3 (bottom view) displays the underside of said work platform with attached multi-directional friction-reducing devices (Detail A) positioned to provide maximum stability and maneuverability.

Drawing 4 Demonstrates a workman utilizing work platform and the approximate height, with platform thickness, support height/size ratio and proportion.

### Operation

Said work platform with its tip-resistant stability, and multi-directional maneuverability is designed specifically to accommodate a workman while performing a variety of floor level work operations in a range of work locations.

In operation, a workman places said work platform on a floor surface and commences to sit on it and remain seated while working. A move from one work location to another is accomplished simply with the push or thrust of extending a hand, arm, leg or foot.

### Advantages

The common method of performing floor level work operations requiring actions such as kneeling, bending, crouching and then standing erect and walking to the next work location is replaced with an improved method; a floor level rolling work platform whereby a workman sits and remains seated while performing a range of work operations and propels himself from one work location to another with the push or thrust of extending a hand, arm, leg or foot. All features, static and functional, are illustrated in (Drawings 1-4).

1. A low-profile rolling work platform comprising:
a) a platform constructed of rigid material sized to seat a single workman with said platform having a solid undersurface and
b) a plurality of multidirectional friction-reducing devices such as casters attached to the platform underside with said devices being of predetermined size, quantity and position to maximize stability and multidirectional mobility and
c) thereby providing a means by which a workman can sit and remain seated while moving from one work location to another by the thrust of a hand, arm, leg or foot and eliminating the existing method of crouching, bending or kneeling and then standing erect and walking to reach a new location.
